(19) United States
(12) Patent Application Publication
(10) Pub. No.: US 2014/0002338 A1
(43) Pub. Date: Jan. 2, 2014

(54) TECHNIQUES FOR POSE ESTIMATION AND FALSE POSITIVE FILTERING FOR GESTURE RECOGNITION

(71) Applicants: GIUSEPPE RAFFA, Portland, OR (US); SANGITA SHARMA, Portland, OR (US); JUNAITH AHEMED SHAHABDEEN, San Jose, CA (US)

(72) Inventors: GIUSEPPE RAFFA, Portland, OR (US); SANGITA SHARMA, Portland, OR (US); JUNAITH AHEMED SHAHABDEEN, San Jose, CA (US)

(73) Assignee: INTEL CORPORATION, Santa Clara, CA (US)

(21) Appl. No.: 13/536,262

(22) Filed: Jun. 28, 2012

(51) Int. Cl. G09G 5/00

(52) U.S. Cl. 345/156

(57) ABSTRACT

Techniques for pose estimation and false positive filtering for gesture recognition are described. For example, a method may comprise receiving data from one or more sensors indicating motion of an electronic device, determining if the motion comprises a gesture motion using one or more statistical gesture recognition algorithms, determining a start pose and an end pose for the gesture motion, determining if the start pose and end pose of the gesture motion correspond to a start pose and end pose of a gesture model corresponding to the gesture motion, and triggering a gesture event if the start pose and end pose of the gesture motion match the start pose and end pose of the gesture model. Other embodiments are described and claimed.

### BACKGROUND

Gesture interfaces based on inertial sensors such as accelerometers and gyroscopes embedded in small form factor electronic devices are becoming increasingly common in user devices such as smart phones, remote controllers and game consoles. In the mobile space, gesture interaction is an attractive alternative to traditional interfaces because it does not involve the shrinking of the form factor of traditional input devices such as a keyboard, mouse or screen. In addition, gesture interaction is more supportive of mobility, as users can easily perform subtle gestures as they perform other activities such as walking or driving.

“Dynamic 3D gestures” are based on atomic movements of a user using inertial sensors such as micro-electromechanical system (MEMS) based accelerometers and gyroscopes. Statistical recognition algorithms, such as Hidden Markov Model algorithms (HMM), are widely used for gesture and speech recognition and many other machine learning tasks. Research has shown HMM to be extremely effective for recognizing complex gestures and enabling rich gesture input vocabularies. However, due to the nature of statistical algorithms including the necessary feature extraction and normalization employed to deal with gesture-to-gesture and user-to-user variability, these algorithms often suffer from a high rate of false positives that negatively impact the performance of the system and the user experience. It is with respect to these and other considerations that the present improvements have been needed.

### BRIEF DESCRIPTION OF THE DRAWINGS

FIG. 1 illustrates an embodiment of a first system.

FIG. 2 illustrates an embodiment of a second system

FIG. 3A illustrates an embodiment of a first operating environment.

FIG. 3B illustrates an embodiment of a second operating environment.

FIG. 4 illustrates an embodiment of a first sensor data.

FIG. 5 illustrates an embodiment of a second sensor data.

FIG. 6A illustrates an embodiment of a first logic flow.

FIG. 6B illustrates an embodiment of a second logic flow.

FIG. 7 illustrates an embodiment of a computing architecture.

### DETAILED DESCRIPTION

Various embodiments are generally directed to techniques for pose estimation and false positive filtering for gesture recognition. Some embodiments are particularly directed to using start and end physical poses of a gesture as a mechanism to filter discrete gestures that are recognized by probabilistic methods such as HMM. The embodiments described herein combine the flexibility of statistical methods to build rich gesture vocabularies with deterministic methods to constrain gesture recognition to only movements that satisfy certain physical characteristics, such as particular gesture start and end poses. The pose estimation and false positive filtering techniques for gesture recognition described herein operate to significantly increase the reliability and simplicity of electronic device gesture recognition, thereby enhancing device performance, user productivity, convenience, and experience, in particular because false positives may create a significant problem for systems intended to run continuously on a device.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

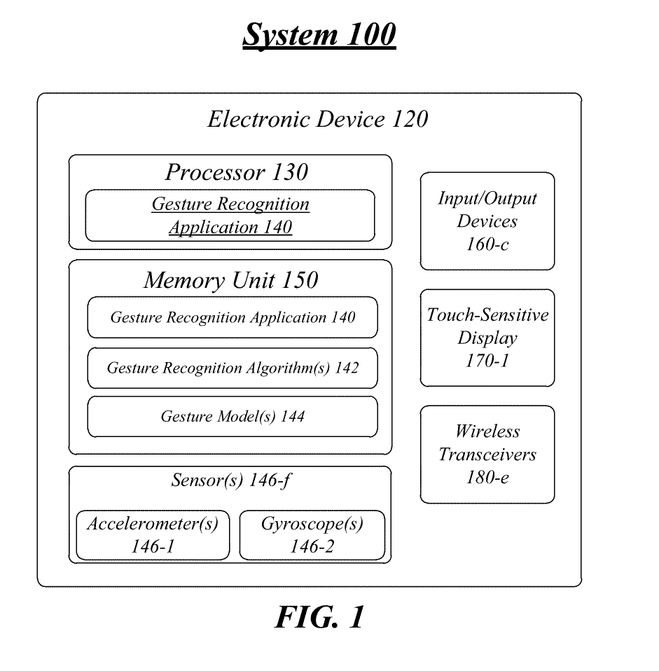

FIG. 1 illustrates a block diagram for a system 100 or an apparatus 100. In one embodiment, the system or apparatus 100 (referred to hereinafter as system 100) may comprise a computer-based system comprising one or more computing devices or, as referred to hereinafter, electronic device 120. The electronic device 120 may comprise, for example, a processor 130, a memory unit 150, input/output devices 160-c, displays 170-d, one or more transceivers 180-e, and one or more sensors 146-f. In some embodiments, the sensors 146-f may include one or more accelerometers 146-1 and/or gyroscopes 146-2. The electronic device 120 may further have installed or comprise a gesture recognition application 140. The memory unit 150 may store an unexecuted version of the gesture recognition application 140 and one or more gesture recognition algorithms 142 and gesture models 144. While the gesture recognition algorithms 142 and gesture models 144 are shown as separate components or modules in FIG. 1, it should be understood that one or more of gesture recognition algorithms 142 and gesture models 144 could be part of gesture recognition algorithm 140 and still fall within the described embodiments. Also, although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for e=5, then a complete set of wireless transceivers 180 may include wireless transceivers 180-1, 180-2, 180-3, 180-4 and 180-5. The embodiments are not limited in this context.

In various embodiments, the system 100 may comprise electronic devices 120. Some examples of an electronic device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In various embodiments, electronic device 120 of the system 100 may comprise a processor 130. The processor 130 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processing 130.

In various embodiments, electronic device 120 of the system 100 may comprise a memory unit 150. The memory unit 150 may store, among other types of information, the gesture recognition application 140, gesture recognition algorithms 142 and gesture models 144. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

In various embodiments, the system 100 may comprise one or more input/output devices 160-c. The one or more input/output devices 160-c may be arranged to provide functionality to the electronic device 120 including but not limited to capturing images, exchanging information, capturing or reproducing multimedia information, determining a location of the electronic device 120 or any other suitable functionality. Non-limiting examples of input/output devices 160-c include a camera, QR reader/writer, bar code reader, a global positioning system (GPS) module, and a display 170-d coupled with an electronic device 120. The embodiments are not limited in this respect.

The electronic device 120 may comprise one or more displays 170-d in some embodiments. The displays 170-d may comprise any digital display device suitable for the electronic devices 120. For instance, the displays 170-d may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content to a user of the electronic devices 120. The displays 170-d may further include some form of a backlight or brightness emitter as desired for a given implementation.

In various embodiments, the displays 170-d may comprise touch-sensitive or touchscreen displays. A touchscreen may comprise an electronic visual display that is operative to detect the presence and location of a touch within the display area or touch interface. In some embodiments, the display may be sensitive or responsive to touching of the display of the device with a finger or hand. In other embodiments, the display may be operative to sense other passive objects, such as a stylus or electronic pen. In various embodiments, displays 170-d may enable a user to interact directly with what is displayed, rather than indirectly with a pointer controlled by a mouse or touchpad. Other embodiments are described and claimed.

The electronic device 120 may comprise one or more wireless transceivers 180-e. Each of the wireless transceivers 180-e may be implemented as physical wireless adapters or virtual wireless adapters sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 180-e may comprise or implement various communication techniques to allow the electronic device 120 to communicate with other electronic devices. For instance, the wireless transceivers 180-e may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the electronic device 120 may implement different types of wireless transceivers 180-e. Each of the wireless transceivers 180-e may implement or utilize a same or different set of communication parameters to communicate information between various electronic devices. In one embodiment, for example, each of the wireless transceivers 180-e may implement or utilize a different set of communication parameters to communicate information between electronic device 120 and a remote device. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers 180-e. The embodiments are not limited in this context.

In various embodiments, the wireless transceivers 180-e may implement different communication parameters offering varying bandwidths, communications speeds, or transmission range. For instance, a first wireless transceiver 180-1 may comprise a short-range interface implementing suitable communication parameters for shorter range communications of information, while a second wireless transceiver 180-2 may comprise a long-range interface implementing suitable communication parameters for longer range communications of information.

In various embodiments, the terms “short-range” and “long-range” may be relative terms referring to associated communications ranges (or distances) for associated wireless transceivers 180-e as compared to each other rather than an objective standard. In one embodiment, for example, the term “short-range” may refer to a communications range or distance for the first wireless transceiver 180-1 that is shorter than a communications range or distance for another wireless transceiver 180-e implemented for the electronic device 120, such as a second wireless transceiver 180-2. Similarly, the term “long-range” may refer to a communications range or distance for the second wireless transceiver 180-2 that is longer than a communications range or distance for another wireless transceiver 180-e implemented for the electronic device 120, such as the first wireless transceiver 180-1. The embodiments are not limited in this context.

In various embodiments, the terms “short-range” and “long-range” may be relative terms referring to associated communications ranges (or distances) for associated wireless transceivers 180-e as compared to an objective measure, such as provided by a communications standard, protocol or interface. In one embodiment, for example, the term “short-range” may refer to a communications range or distance for the first wireless transceiver 180-1 that is shorter than 300 meters or some other defined distance. Similarly, the term “long-range” may refer to a communications range or distance for the second wireless transceiver 180-2 that is longer than 300 meters or some other defined distance. The embodiments are not limited in this context.

In one embodiment, for example, the wireless transceiver 180-1 may comprise a radio designed to communicate information over a wireless personal area network (WPAN) or a wireless local area network (WLAN). The wireless transceiver 180-1 may be arranged to provide data communications functionality in accordance with different types of lower range wireless network systems or protocols. Examples of suitable WPAN systems offering lower range data communication services may include a Bluetooth system as defined by the Bluetooth Special Interest Group, an infra-red (IR) system, an Institute of Electrical and Electronics Engineers (IEEE) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented, and the embodiments are not limited in this context.

In one embodiment, for example, the wireless transceiver 180-2 may comprise a radio designed to communicate information over a wireless local area network (WLAN), a wireless metropolitan area network (WMAN), a wireless wide area network (WWAN), or a cellular radiotelephone system. The wireless transceiver 180-2 may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver 180-2 may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

In various embodiments, sensors 146-f may comprise any combination of inertial sensors capable of determining or detecting an orientation and/or movement of electronic device 120. For example, in some embodiments the sensors 146-f may comprise one or more accelerometers 146-1 and/or one or more gyroscopes 146-2. Any suitable type of accelerometer 146-1 and/or gyroscope 146-2 could be used and still fall within the described embodiments as one skilled in the art would readily understand. In some embodiments, the accelerometer 146-1 and/or gyroscope 146-2 may comprise or be implemented using microelectromechanical systems (MEMS) technology. The embodiments are not limited in this respect.

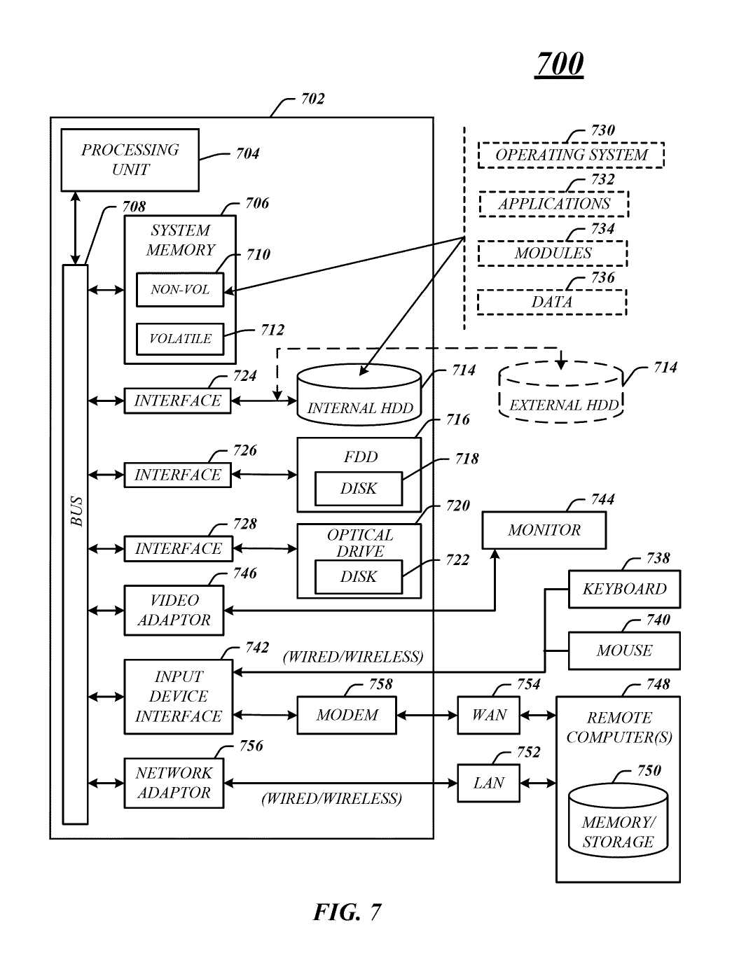

Although not shown, the electronic device 120 may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 7. The embodiments, however, are not limited to these examples.

In the illustrated embodiment shown in FIG. 1, the processor 130 may be communicatively coupled to the wireless transceivers 180-e and the memory unit 150. The memory unit 150 may store a gesture recognition application 140 arranged for execution by the processor 130 to recognize gesture inputs. The gesture recognition application 140 may generally provide features to combine the flexibility of statistical methods to build rich gesture vocabularies with deterministic methods to constrain the recognition to only those movements that satisfy certain physical characteristics, such as gesture start and end poses. More particularly, the gesture recognition application 140 may provide features to use the start and end physical pose of a gesture as a mechanism to filter discrete gestures that are recognized by probabilistic methods such as HHM. Other embodiments are described and claimed.

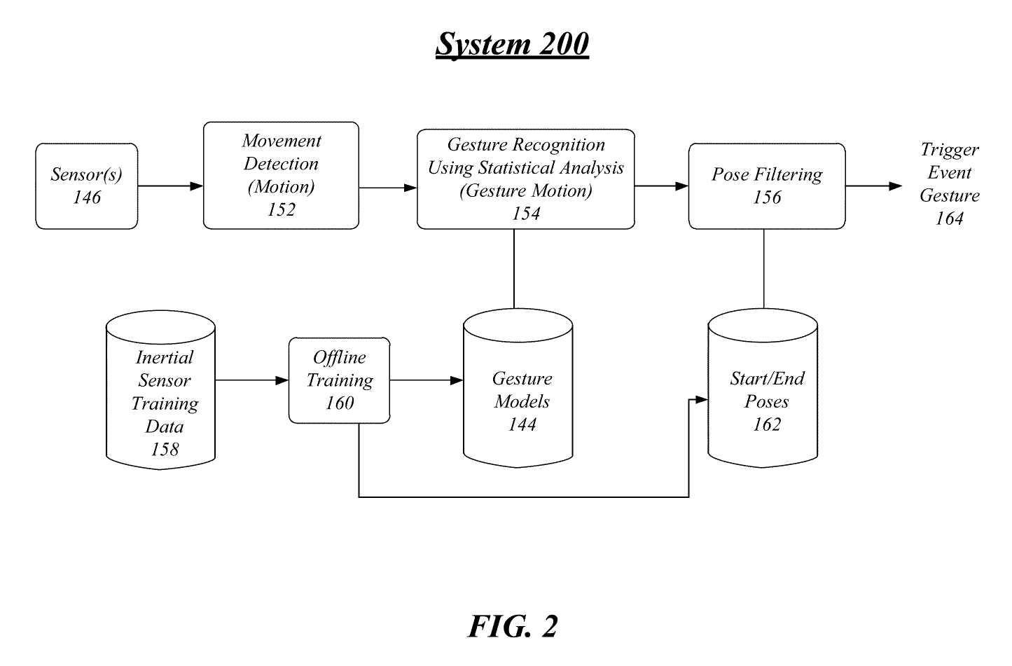

FIG. 2 illustrates a block diagram for a system 200. In some embodiments, the system 200 may represent a portion of system 100 of FIG. 1 or a functional block diagram for the system 100 of FIG. 1. For example, system 200 may comprise a functional block diagram for pose estimation and false filtering for gesture recognition as performed by electronic device 120 of FIG. 1.

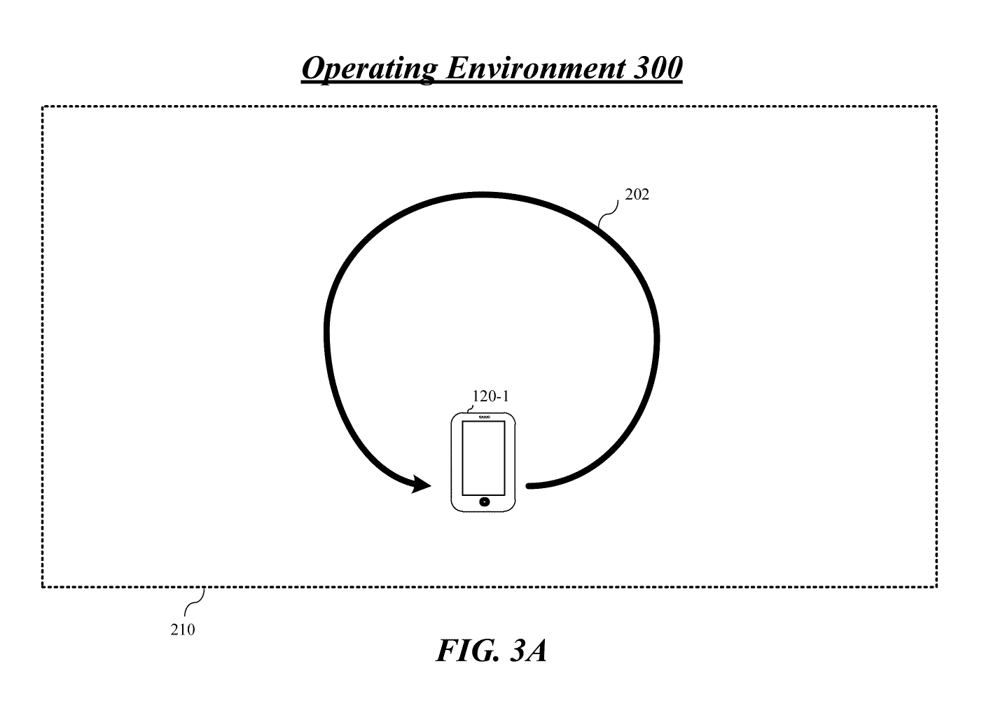

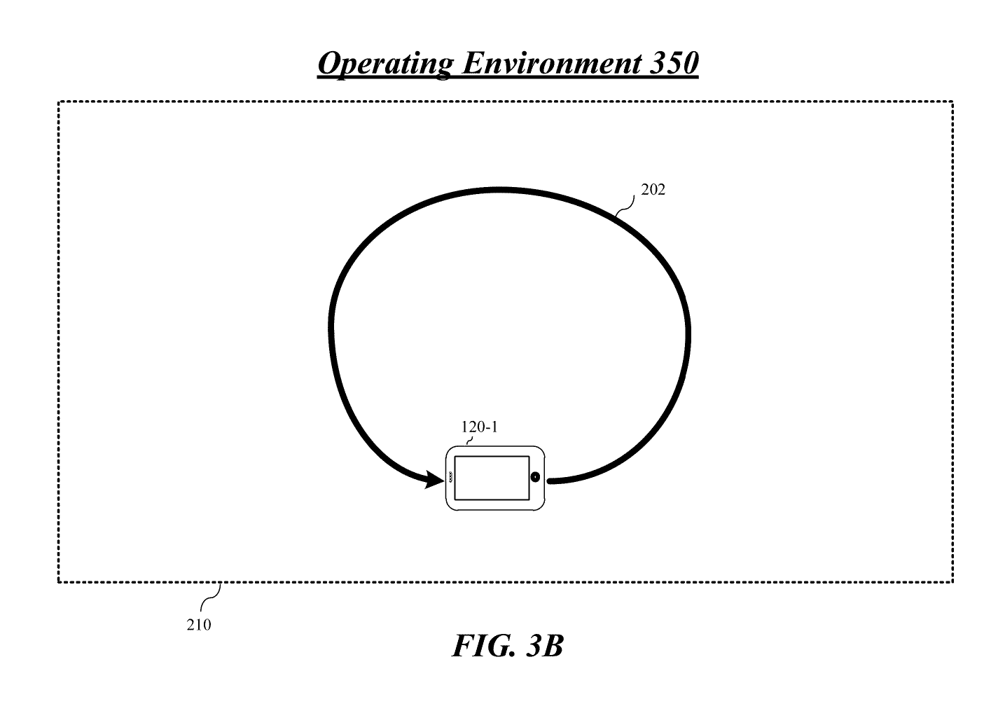

In various embodiments, a user of electronic device 120 may desire to perform an action or cause the electronic device 120 to perform an action based on a gesture movement. For example, responsive to a user moving the electronic device 120 in a predefined manner, the electronic device 120 may perform a certain action or actions. FIGS. 3A and 3B illustrate embodiments of operating environments 300 and 350 respectively that depict example gesture motions.

FIG. 3A illustrates an embodiment of an operating environment 300 for the systems 100 and/or 200. More particularly, the operating environment 300 may illustrate a gesture motion 202 made using electronic device 120. As shown in FIG. 3A, electronic device 120 may start in a portrait position and may be rotated in a circle in a manner depicted by gesture motion 202. For example, while not shown, a user may hold electronic device 120 in their hand in front of them in the portrait mode configuration shown (e.g. start pose), and may draw a circle in the air with the electronic device 120, returning to the original position (e.g. end pose). In various embodiments, this movement may be detected by sensor 146-f of electronic device 120 and may be analyzed and acted upon by gesture recognition application 140.

FIG. 3B illustrates an embodiment of an operating environment 350 for the systems 100 and/or 200. More particularly, the operating environment 350 may illustrate a gesture motion 202 made using electronic device 120. As shown in FIG. 3B, electronic device 120 may start in a landscape position and may be rotated in a circle in a manner depicted by gesture motion 202. For example, while not shown, a user may hold electronic device 120 in their hand in front of them in the landscape mode configuration shown (e.g. start pose), and may draw a circle in the air with the electronic device 120, returning to the original position (e.g. end pose). In various embodiments, this movement may be detected by sensor 146-f of electronic device 120 and may be analyzed and acted on by gesture recognition application 140.

While the gesture motions 202 in FIGS. 3A and 3B appear to be the same, electronic device 120 may be operative to perform different actions based on these movements based on the different start and end poses (e.g. portrait versus landscape position of the electronic device 120) or the system may be operative to recognize one gesture motion (e.g. the portrait configuration) and ignore another gesture motion (e.g. the landscape configuration). Moreover, while the start pose and end poses depicted in FIGS. 3A and 3B appear to be the same (e.g. a same position in front of the user, for example), it should be understood that any start pose and end pose could be used and still fall within the described embodiments. For example, the user could start the gesture motion 202 with the electronic device 120 in the portrait position (e.g. start pose) and may end the gesture motion 202 with the electronic device 120 in a landscape position (e.g. end pose). Furthermore, the electronic device 120 may start in a first position (e.g. start pose) and end in a second, different position (e.g. end pose) such as starting to a right side of a user and end to a left side of the user. These are non-limiting examples of any number of possible gesture motions as would be readily understood by one skilled in the art.

The gesture motions 202 may be associated with any number of actions as will be understood by those skilled in the art. For example, a movement of the electronic device 120 from right to left may cause the electronic device 120 to cause an Internet browser application to jump back to a previously visited page, while a shaking of the electronic device 120 may cause the electronic device 120 to clear entries on a form or undue a previous action. The embodiments are not limited in this respect. In fact, while only a circular gesture motion 202 is depicted in FIGS. 3A and 3B, it should be understood that any detectable gesture motion could be used and still fall within the described embodiments. For example, shaking the electronic device 120, performing a movement representing any number of letters, numbers or shapes with electronic device 120 in the air or any other suitable movement or motion of the electronic device 120.

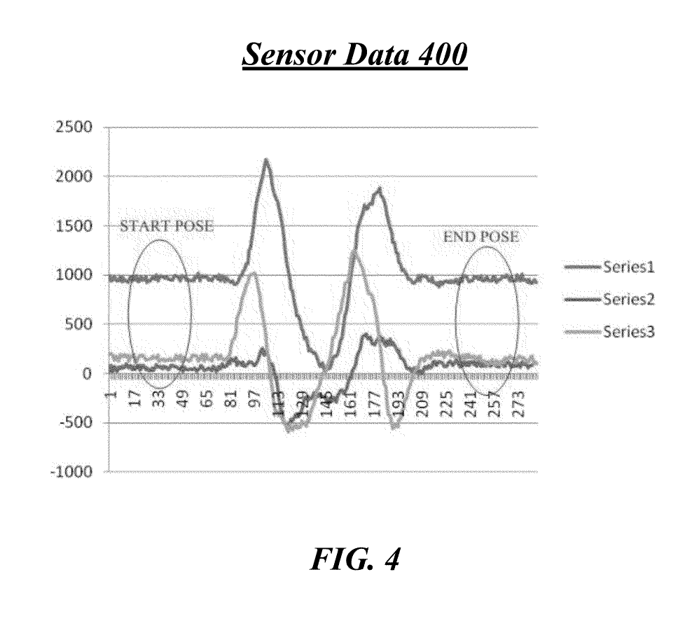

Gesture motions (e.g. discrete gestures) may be defined by a specific movement that is preceded and followed by no movement or very little movement. For example, readings from the sensors 146-f just before and just after a gesture is performed may represent no significant device movement. FIG. 4 illustrates one embodiment of sensor data 400. In some embodiments, the sensor data 400 may be representative of information from one or more sensors (e.g. sensor 146-f) in connection with a gesture motion. As shown in sensor data 400, the portions of the sensor data representing the start pose and end pose are relatively stable, reflective of the fact that no significant movement is detected before or after the gesture motion is performed. Focusing, in part, on this phenomenon may enable system 100/200 to more easily recognize, more accurately identify and reduce the number of false positives associated with gesture recognition.

Returning to FIG. 2, with continuing reference to system 100 and electronic device 120 of FIG. 1, the systems 100/200 may be operative to use a database of trained gestures or gesture models 144 to analyze any number of gesture motions. For example, the gesture models 144 may be developed based on inertial sensor training data 158 and/or offline training 160 where gesture motions are performed (possibly repeatedly) using electronic device 120 and the motions are tracked and recorded. In some embodiments, this may occur during a training phase where a user can select or is prompted to perform one or more gesture motions and the gesture motions are associated with one or more activities or tasks. In other embodiments, the gesture models 144 may be pre-defined and/or pre-loaded onto electronic device 120. Other embodiments are described and claimed.

In addition to storing gesture models 144, start and end poses 162 may also be stored in some embodiments. For example, as part of offline training 160, start poses and end poses associate with gesture motions may be identified based on accelerometer readings that are stationary before and after a pose. The systems 100/200 may be operative to establish the start/end poses 162 using, for example, three accelerometer axes Ax, Ay, Az measurements using bounding boxes or a Gaussian model using average Ax, Ay, Az values (+/−3 standard deviation) to identify the start and end pose for each gesture. The start and end poses 162 may be used for pose filtering in some embodiments.

In various embodiments, once the system 100/200 recognizes that a movement is a gesture-like movement but the start and/or end pose do not match those of the trained gesture motions and start and/or end poses, the system may be operative to provide feedback to a user. The feedback may inform the user why their gesture did not get recognized (e.g. an error message may be generated indicating that the start and/or end pose was not recognized or supported). In some embodiments, this may provide training to the user to assist with correctly performing the gestures and starting and stopping in/for the correct poses and may ease the user learning curve and improve the user experience and usability by providing the user with continuous (or nearly continuous) feedback from the system as incorrect poses may hinder the accuracy of the gesture recognition system 100/200.

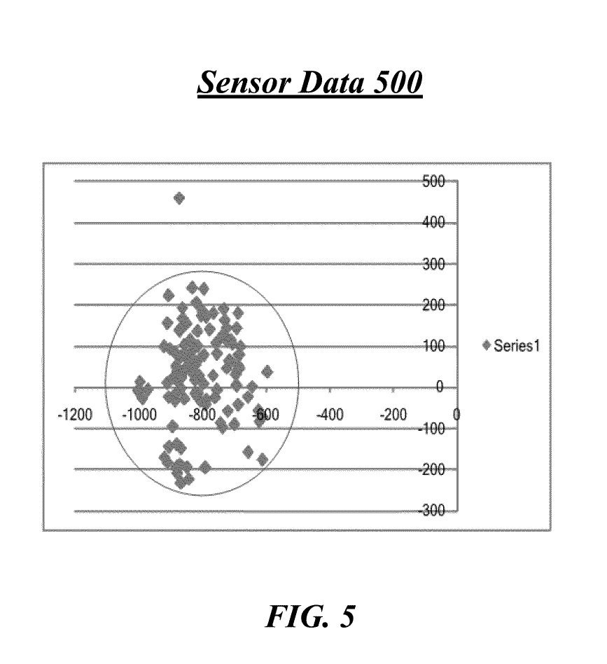

FIG. 5 illustrates sensor data 500. In some embodiments, sensor data 500 may illustrate approximately one hundred poses (Ay v. Az) for a left-flick gesture performed, for example, using electronic device 120. In some embodiments, the sensor data 500 may be part of a training session used to identify a start pose, for example. As shown in the sensor data 500, all of the training start poses (except one) can be represented by a cluster or bounding box. This repeatability of a start pose when executing a gesture enables systems 100/200 to rely effectively on start poses and similarly to rely on end poses (not shown). Other embodiments are described and claimed.

Based on the gesture models 144 and the start and end poses 162, systems 100/200 may be operative to enable robust gesture recognition including pose estimation for false positive filtering in some embodiments. As opposed to simply relying on gesture recognition algorithms and statistical analysis to identify gesture motions as has been done in the past, the embodiments described herein additionally employ pose filtering 156 to increase the accuracy of or otherwise enhance the gesture recognition process.

In various embodiments, gesture recognition application 140 may be operative on processor 130 to receive data from one or more sensors 146-f indicating motion (e.g. movement detection 152) of the apparatus or electronic device 120. For example, responsive to a user performing a gesture motion with electronic device 120, one or more of accelerometer(s) 146-1 and/or gyroscope(s) 146-2 may be operative to sense the movement and raw data from the accelerometer(s) 146-1 and/or gyroscope(s) 146-2 may be provided to gesture recognition application 140 for interpretation and analysis. Based on the detected movement or gesture motion, gesture recognition application 140 may be operative on processor 130 to determine if the motion comprises a gesture motion using one or more gesture recognition algorithms 142. For example, gesture recognition using statistical analysis 154 may be performed on the motion gesture 152 to determine if the detected movement 152 comprises a gesture movement, such as a movement corresponding to one or more of gesture models 144, or another (possibly inadvertent) movement of electronic device 120. The gesture recognition application 140 may be operative on the processor 130 to compare the gesture motion to a gesture motion database (e.g. gesture models 144) comprising a plurality of trained gesture motions corresponding to gesture models. In some embodiments, the one or more gesture recognition algorithms may be based on one or more of a Hidden Markov Model (HMM), Bayesian network or neural network.

Gesture recognition application 140 may be operative on processor 130 to determine a start pose and an end pose for the gesture motion in some embodiments. For example, after determining that the detected movement comprises a gesture movement, the start and end poses may be calculated as described above. 18. In some embodiments, the start pose may comprise position and orientation information for the apparatus or electronic device 120 before the motion is performed and the end pose may comprise position and orientation information for the apparatus after the motion is performed.

Using the start and end poses for the gesture motion, gesture recognition application 140 may be operative on processor 130 to determine if the start pose and end pose of the gesture motion correspond to a start pose and end pose of a gesture model (e.g. using start/end poses 162) corresponding to the gesture motion. If a match is found, a gesture event may be triggered at 164. If, on the other hand, no match is found, the gesture motion may be disregarded.

Identification of the start pose may require sensor 164-f data that is collected just before the motion is detected. To this end, the movement detection stage 152 of the gesture recognition application 140 processing may include or be operative on the processor 130 to continuously buffer data received from the one or more sensors 146-f. For example, the gesture recognition application 140 may utilize (e.g. averaging) the last N samples for the detection of a start pose just before a start-of-motion is detected. Because motion detection runs continuously to ensure that motion is captured, this buffering may have little or no power impact on the systems 100/200.

Detection of the end pose may require sensor 146-f data that is collected after the end of a motion is detected. A small delay in recognizing the gesture is introduced because the system keeps collecting sensor 146-f data for a small amount of time after the motion end (e.g. a few milliseconds). In various embodiments, even without pose detection as described herein, the gesture recognition algorithms 142 of the gesture recognition application 140 may need to wait until the sensor 146-f data signals stabilize in order to signal an end-of-motion. As a result, the addition pose filtering step introduced in the described embodiments does not add a significant delay in triggering a gesture event, while at the same time significantly reducing false positives.

In various embodiments, the gesture recognition application 140 may be operative on the processor 130 to determine the start pose and end pose for the gesture motion based on the buffered data. For example, the buffered data (e.g. sensor 146-f data from just before the start-of-motion and just after the end-of-motion) may be stored in memory unit 150 for use in determining the start pose and end pose. In other embodiments, the gesture recognition application 140 may be operative on the processor 130 to identify a subset of the plurality of trained gestured motions (e.g. gesture models 144) based on the start pose and end pose of the gesture motion. Other embodiments are described and claimed.

While shown and described in FIG. 2 as occurring after the gesture recognition using statistical analysis 154, in some embodiments pose filtering 156 may occur before the gesture recognition using statistical analysis 156 or in any other suitable location or at any other suitable time in the gesture recognition processing. This may result in power savings for the systems 100/200 by avoiding the need to perform the statistical analysis which may be computationally and power intensive. For example, in these embodiments, data may be received from one or more sensors 146-f indicating motion of an electronic device and a start and end pose for the motion may be determined. For example, gesture recognition application 140 may be operative on processor 130 to compare a start and end pose for the detected movement or motion 152 to the start/end poses 162 and to determine if the start pose and end pose of the motion correspond to a start pose and end pose of a gesture motion.

If a match is found, the motion may be identified as a gesture motion using one or more gesture recognition algorithms (e.g. gesture recognition using statistical analysis 154) and a gesture event may be triggered 164 based on the identified gesture motion. If no match is found, the motion may be ignored or disregarding and the one or more gesture recognition algorithms 142 need not be applied resulting in possible power and time savings for the electronic device 142. Other embodiments are described and claimed.

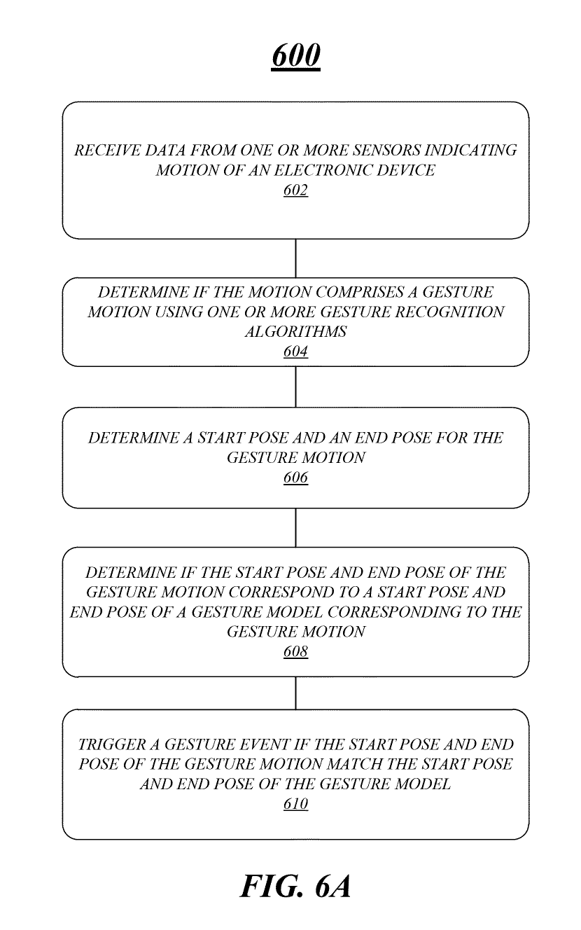

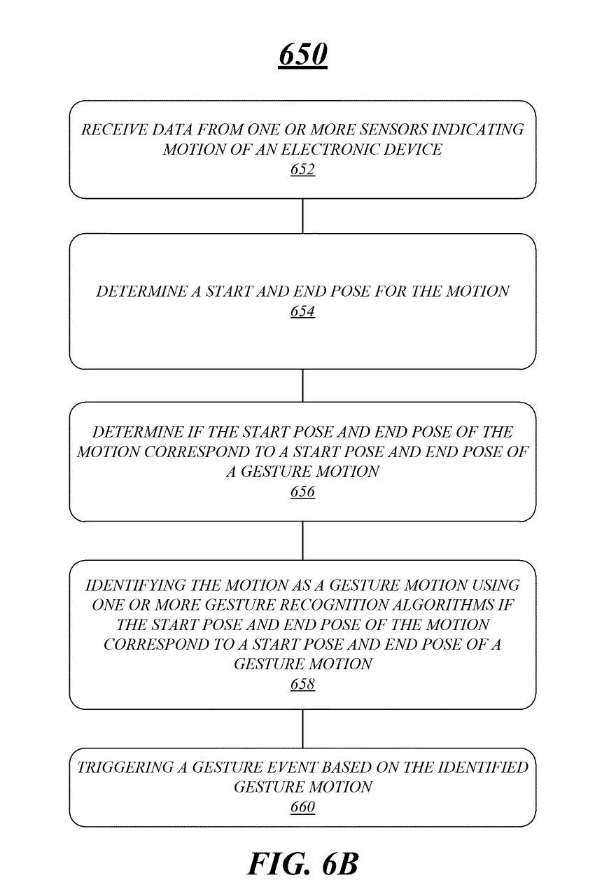

FIG. 6A illustrates one embodiment of a logic flow 600. The logic flow 600 may be representative of some or all of the operations executed by one or more embodiments described herein. For example, the logic flow 600 may illustrate operations performed by the systems 100/200 and, more particularly, an electronic device 120 of a systems 100/200.

In the illustrated embodiment shown in FIG. 6A, the logic flow 600 may include receiving data from one or more sensors indicating motion of an electronic device at 602. For example, data from sensors 146-f may be received by gesture recognition application 140 of electronic device 120. The one or more sensors may comprise one or more of an accelerometer or a gyroscope and, in some embodiments, the accelerometer or gyroscope may be implemented using microelectromechanical systems (MEMS) technology.

At 604, the logic flow may include determining if the motion comprises a gesture motion using one or more gesture recognition algorithms. For example, gesture recognition application 140 may utilize gesture recognition algorithms 142 to analyze the received motion to determine if the motion comprises a gesture motion. The one or more gesture recognition algorithms may be on one or more of a Hidden Markov Model (HMM), Bayesian network or neural network. In various embodiments, the determination may be made by comparing the gesture motion to a gesture motion database comprising a plurality of trained gesture motions corresponding to gesture models, such as gesture models 144 for example.

In some embodiments, the logic flow may include determining a start pose and an end pose for the gesture motion at 606. For example, the start pose may comprise position and orientation information for the electronic device 120 before the motion is performed and the end pose may comprise position and orientation information for the electronic device 120 after the motion is performed. At 608, the logic flow may include determining if the start pose and end pose of the gesture motion correspond to a start pose and end pose of a gesture model corresponding to the gesture motion. For example, the determined start pose and end pose may be compared to the start/end poses 162.

In various embodiments, the logic flow may include triggering a gesture event if the start pose and end pose of the gesture motion match the start pose and end pose of the gesture model at 610. In other embodiments, the logic flow may include disregarding the gesture motion if the start pose and end pose of the gesture motion do not match the start pose and end pose of the gesture model. The embodiments are not limited in this respect.

In various embodiments, the logic flow may further include (while not shown), identifying a subset of the plurality of trained gestured motions based on the start pose and end pose of the gesture motion. Further, the logic flow may also or alternatively include continuously buffering data received from the one or more sensors and determining the start pose and end pose for the gesture motion based on the buffered data. Other embodiments are described and claimed.

FIG. 6B illustrates one embodiment of a logic flow 650. The logic flow 650 may be representative of some or all of the operations executed by one or more embodiments described herein. For example, the logic flow 650 may illustrate operations performed by the systems 100/200 and, more particularly, an electronic device 120 of the systems 100/200. In various embodiments, the logic flow 650 may represent embodiments were the pose filtering 156 occurs in the system prior to the gesture recognition using statistical analysis.

In the illustrated embodiment shown in FIG. 6B, the logic flow 650 may comprise receiving data from one or more sensors indicating motion of an electronic device at 652. For example, data from sensors 146-f may be received by gesture recognition application 140 of electronic device 120. At 654, the logic may include determining a start and end pose for the motion and at 656 the logic may include determining if the start pose and end pose of the motion correspond to a start pose and end pose of a gesture motion. For example, prior to performing gesture recognition using statistical analysis, the systems 100/200 may be operative to first determine a start and end pose for a motion to screen potentially false positive gesture motions by comparing the start and end pose of the motion to known start and end poses.

In various embodiments, the logic flow may include identifying the motion as a gesture motion using one or more gesture recognition algorithms if the start pose and end pose of the motion correspond to a start pose and end pose of a gesture motion at 658 and triggering a gesture event based on the identified gesture motion at 660. In other embodiments, the logic flow may include disregarding the motion by not applying the one or more gesture recognition algorithms if the start pose and end pose of the motion do not match a start pose and end pose of a gesture motion. For example, the gesture recognition application 140 of electronic device 120 may be operative on processor 130 to perform gesture recognition processing (e.g. using statistical analysis) only if a start and end pose match is found first. The embodiments are not limited in this respect.

FIG. 7 illustrates an embodiment of an exemplary computing architecture 700 suitable for implementing various embodiments as previously described. In one embodiment, the computing architecture 700 may comprise or be implemented as part of an electronic device 120.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, such as those described with reference to the processor 130 shown in FIG. 1.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the touch gesture gesture recognition system 100 as previously described with reference to FIGS. 1-7 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments; examples one through twenty nine (1-29) provided below are intended to be exemplary and non-limiting.

In a first example, a computer-implemented method may comprise receiving data from one or more sensors indicating motion of an electronic device; determining if the motion comprises a gesture motion using one or more gesture recognition algorithms; determining a start pose and an end pose for the gesture motion; determining if the start pose and end pose of the gesture motion correspond to a start pose and end pose of a gesture model corresponding to the gesture motion; and triggering a gesture event if the start pose and end pose of the gesture motion match the start pose and end pose of the gesture model.

In a second example, a computer-implemented method may comprise disregarding the gesture motion if the start pose and end pose of the gesture motion do not match the start pose and end pose of the gesture model.

In a third example, a computer-implemented method may comprise comparing the gesture motion to a gesture motion database comprising a plurality of trained gesture motions corresponding to gesture models.

In a fourth example, a computer-implemented method may comprise identifying a subset of the plurality of trained gestured motions based on the start pose and end pose of the gesture motion.

In a fifth example, a computer-implemented method may comprise continuously buffering data received from the one or more sensors.

In a sixth example, a computer-implemented method may comprise determining the start pose and end pose for the gesture motion based on the buffered data.

In a seventh example of a computer-implemented method, the start pose may comprise position and orientation information for the electronic device before the motion is performed.

In a eighth example of a computer-implemented method, the end pose may comprise position and orientation information for the electronic device after the motion is performed.

In a ninth example of a computer-implemented method, the one or more gesture recognition algorithms may be based on one or more of a Hidden Markov Model (HMM), Bayesian network or neural network.

In a tenth example of a computer-implemented method, the one or more sensors may comprise one or more of an accelerometer or a gyroscope.

In an eleventh example of a computer-implemented method, the accelerometer or gyroscope may be implemented using microelectromechanical systems (MEMS) technology.

In a twelfth example, an apparatus may comprise a processor; and a memory unit coupled to the processor, the memory unit to store a gesture recognition application operative on the processor to receive data from one or more sensors indicating motion of the apparatus, determine if the motion comprises a gesture motion using one or more gesture recognition algorithms, determine a start pose and an end pose for the gesture motion, determine if the start pose and end pose of the gesture motion correspond to a start pose and end pose of a gesture model corresponding to the gesture motion, and trigger a gesture event if the start pose and end pose of the gesture motion match the start pose and end pose of the gesture model.

In a thirteenth example of an apparatus, the gesture recognition application operative on the processor to disregard the gesture motion if the start pose and end pose of the gesture motion do not match the start pose and end pose of the gesture model.

In a fourteenth example of an apparatus, the gesture recognition application operative on the processor to compare the gesture motion to a gesture motion database comprising a plurality of trained gesture motions corresponding to gesture models.

In a fifteenth example of an apparatus, the gesture recognition application operative on the processor to identify a subset of the plurality of trained gestured motions based on the start pose and end pose of the gesture motion.

In a sixteenth example of an apparatus, the gesture recognition application operative on the processor to continuously buffer data received from the one or more sensors.

In a seventeenth example of an apparatus, the gesture recognition application operative on the processor to determine the start pose and end pose for the gesture motion based on the buffered data.

In a eighteenth example of an apparatus, the start pose comprising position and orientation information for the apparatus before the motion is performed.

In a nineteenth example of an apparatus, the end pose comprising position and orientation information for the apparatus after the motion is performed.

In a twentieth example of an apparatus, the one or more gesture recognition algorithms based on one or more of a Hidden Markov Model (HMM), Bayesian network or neural network.

In a twenty first example of an apparatus, the one or more sensors comprising one or more of an accelerometer or a gyroscope.

In a twenty second example of an apparatus, the accelerometer or gyroscope implemented using microelectromechanical systems (MEMS) technology.

In a twenty third example, a system may comprise a processor; one or more sensors coupled to the processor; and a memory unit coupled to the processor, the memory unit to store a gesture recognition application operative on the processor to receive data from the one or more sensors indicating motion of the apparatus, determine if the motion comprises a gesture motion using one or more gesture recognition algorithms, determine a start pose and an end pose for the gesture motion, determine if the start pose and end pose of the gesture motion correspond to a start pose and end pose of a gesture model corresponding to the gesture motion, and trigger a gesture event if the start pose and end pose of the gesture motion match the start pose and end pose of the gesture model.

In a twenty fourth example, the system may comprise one or more wireless transceivers coupled to the processor.

In a twenty fifth example, a computer-implemented method may comprise receiving data from one or more sensors indicating motion of an electronic device; determining a start and end pose for the motion; determining if the start pose and end pose of the motion correspond to a start pose and end pose of a gesture motion; identifying the motion as a gesture motion using one or more gesture recognition algorithms if the start pose and end pose of the motion correspond to a start pose and end pose of a gesture motion; and triggering a gesture event based on the identified gesture motion.

In a twenty sixth example, a computer-implemented method may comprise disregarding the motion by not applying the one or more gesture recognition algorithms if the start pose and end pose of the motion do not match a start pose and end pose of a gesture motion.

In a twenty seventh example, a computer-implemented method may comprise continuously buffering data received from the one or more sensors; and determining the start pose and end pose for the motion based on the buffered data; the start pose comprising position and orientation information for the electronic device before the motion is performed and the end pose comprising position and orientation information for the electronic device after the motion is performed.

In a twenty eighth example of a computer-implemented method, the one or more gesture recognition algorithms may be based on one or more of a Hidden Markov Model (HMM), Bayesian network or neural network.

In a twenty ninth example of a computer-implemented method, the one or more sensors may comprise one or more of an accelerometer or a gyroscope implemented using microelectromechanical systems (MEMS) technology.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An article comprising a machine-readable storage medium containing instructions that if executed enable a system to:
receive data corresponding to motion of an electronic device captured by one or more sensors;
determine if the motion comprises a gesture motion using one or more gesture recognition algorithms;
determine a start pose and an end pose for the gesture motion;
determine if the start pose and end pose of the gesture motion correspond to a start pose and end pose of a gesture model corresponding to the gesture motion; and
trigger a gesture event if the start pose and end pose of the gesture motion match the start pose and end pose of the gesture model.

2. The article of claim 1, comprising instructions that if executed enable the system to:
disregard the gesture motion if the start pose and end pose of the gesture motion do not match the start pose and end pose of the gesture model.

3. The article of claim 1, determining if the motion comprises a gesture motion comprising comparing the gesture motion to a gesture motion database comprising a plurality of trained gesture motions corresponding to gesture models.

4. The article of claim 1, determining a start pose and an end pose comprising identifying a subset of the plurality of trained gestured motions based on the start pose and end pose of the gesture motion.

5. The article of claim 1, comprising instructions that if executed enable the system to:
continuously buffer data received from the one or more sensors.

6. The article of claim 5, comprising instructions that if executed enable the system to:
determine the start pose and end pose for the gesture motion based on the buffered data.

7. The article of claim 6, the start pose comprising position and orientation information for the electronic device before the motion is performed.

8. The article of claim 6, the end pose comprising position and orientation information for the electronic device after the motion is performed.

9. The article of claim 1, the one or more gesture recognition algorithms based on one or more of a Hidden Markov Model (HMM), Bayesian network or neural network.

10. The article of claim 1, the one or more sensors comprising one or more of an accelerometer or a gyroscope.

11. The article of claim 10, the accelerometer or gyroscope implemented using microelectromechanical systems (MEMS) technology.

12. A system, comprising:
a processor;
one or more sensors coupled to the processor; and
a memory unit coupled to the processor, the memory unit to store instructions operative on the processor to receive data corresponding to motion of the system captured by one or more sensors, determine if the motion comprises a gesture motion, determine a start pose and an end pose for the gesture motion, determine if the start pose and end pose of the gesture motion correspond to a start pose and end pose of a gesture model corresponding to the gesture motion, and trigger a gesture event if the start pose and end pose of the gesture motion match the start pose and end pose of the gesture model.

13. The system of claim 12, the instructions operative on the processor to disregard the gesture motion if the start pose and end pose of the gesture motion do not match the start pose and end pose of the gesture model.

14. The system of claim 12, the instructions operative on the processor to compare the gesture motion to a gesture motion database comprising a plurality of trained gesture motions corresponding to gesture models.

15. The system of claim 14, the instructions operative on the processor to identify a subset of the plurality of trained gestured motions based on the start pose and end pose of the gesture motion.

16. The system of claim 12, the instructions operative on the processor to continuously buffer data received from the one or more sensors.

17. The system of claim 16, the instructions operative on the processor to determine the start pose and end pose for the gesture motion based on the buffered data.

18. The system of claim 17, the start pose comprising position and orientation information for the apparatus before the motion is performed.

19. The system of claim 17, the end pose comprising position and orientation information for the apparatus after the motion is performed.

20. The system of claim 12, the one or more gesture recognition algorithms based on one or more of a Hidden Markov Model (HMM), Bayesian network or neural network.

21. The system of claim 12, the one or more sensors comprising one or more of an accelerometer or a gyroscope.

22. The system of claim 21, the accelerometer or gyroscope implemented using microelectromechanical systems (MEMS) technology.

23. An article comprising a machine-readable storage medium containing instructions that if executed enable a system to:
receive data corresponding to motion of an electronic device captured by one or more sensors;
determine a start and end pose for the motion;
determine if the start pose and end pose of the motion correspond to a start pose and end pose of a gesture motion;
identify the motion as a gesture motion using one or more gesture recognition algorithms if the start pose and end pose of the motion correspond to a start pose and end pose of a gesture motion; and
trigger a gesture event based on the identified gesture motion.

24. The article of claim 23, comprising instructions that if executed enable the system to:
disregard the motion by not applying the one or more gesture recognition algorithms if the start pose and end pose of the motion do not match a start pose and end pose of a gesture motion.

25. The article of claim 23, comprising instructions that if executed enable the system to:
continuously buffer data received from the one or more sensors; and
determine the start pose and end pose for the motion based on the buffered data;
the start pose comprising position and orientation information for the electronic device before the motion is performed and the end pose comprising position and orientation information for the electronic device after the motion is performed.

26. The article of claim 25, the one or more gesture recognition algorithms based on one or more of a Hidden Markov Model (HMM), Bayesian network or neural network.

27. The article of claim 25, the one or more sensors comprising one or more of an accelerometer or a gyroscope implemented using microelectromechanical systems (MEMS) technology.

28. A system, comprising:
a processor;
one or more sensors coupled to the processor; and
a memory unit coupled to the processor, the memory unit to store instructions operative on the processor to receive data corresponding to motion of the system captured by one or more sensors, determine a start and end pose for the motion, determine if the start pose and end pose of the motion correspond to a start pose and end pose of a gesture motion, identify the motion as a gesture motion using one or more gesture recognition algorithms if the start pose and end pose of the motion correspond to a start pose and end pose of a gesture motion, and trigger a gesture event based on the identified gesture motion.

29. The system of claim 28, the instructions operative on the processor to disregard the motion by not applying the one or more gesture recognition algorithms if the start pose and end pose of the motion do not match a start pose and end pose of a gesture motion.

30. The system of claim 28, the instructions operative on the processor to continuously buffer data received from the one or more sensors and determine the start pose and end pose for the motion based on the buffered data, the start pose comprising position and orientation information for the electronic device before the motion is performed and the end pose comprising position and orientation information for the electronic device after the motion is performed.

31. The system of claim 28, the one or more gesture recognition algorithms based on one or more of a Hidden Markov Model (HMM), Bayesian network or neural network and the one or more sensors comprising one or more of an accelerometer or a gyroscope implemented using microelectromechanical systems (MEMS) technology.
